(19) United States
(12) Patent Application Publication
(10) Pub. No.: US 2026/0112769 A1
(43) Pub. Date: Apr. 23, 2026

(54) BATTERY MODULE

(71) Applicants: Hyundai Motor Company, Seoul (KR); Kia Corporation, Seoul (KR)

(72) Inventors: Hyun Chang Kang, Hwaseong (KR); Jun Young Kang, Hwaseong (KR); Jeong Hun Seo, Hwaseong (KR); Jun Seok Choi, Hwaseong (KR)

(21) Appl. No.: 19/343,311

(22) Filed: Sep. 29, 2025

(30) Foreign Application Priority Data
Oct. 18, 2024 (KR) 10-2024-0142959
May 20, 2025 (KR) 10-2025-0065507

(51) Int. Cl. H01M 50/383; H01M 50/291; H01M 50/507

(52) U.S. Cl. CPC H01M 50/383; H01M 50/291; H01M 50/507; H01M 2200/10

(57) ABSTRACT

Disclosed is a battery module. The battery module includes a plurality of battery cells that are arranged in a direction, and a sensing assembly that is disposed on surfaces of the plurality of battery cells to face the plurality of battery cells. The sensing assembly includes a busbar that is electrically connected to the plurality of battery cells, a busbar frame that supports the busbar, and a fire extinguishing member that is provided in an area between the busbar frame and the battery cells, and is configured to be exposed in a direction facing the battery cells.

### CROSS-REFERENCE TO RELATED APPLICATION

This application claims, under 35 U.S.C. § 119(a), the benefit of Korean Patent Application No. 10-2024-0142959, filed Oct. 18, 2024, in the Korean Intellectual Property Office, and Korean Patent Application No. 10-2025-0065507, filed May 20, 2025, in the Korean Intellectual Property Office, the entire contents of which are incorporated herein by reference.

### BACKGROUND

### (a) Technical Field

The present disclosure relates to a battery module and to battery module configurations.

### (b) Background

As the demand for electric vehicles continues to increase, the demand for batteries mounted on electric vehicles is also increasing. Depending on the materials of the cathode and anode that constitute the battery, the battery may be classified into various types. Among them, a lithium ion battery is widely used because it has high energy efficiency per unit volume and a lightweight structure. However, lithium-ion batteries pose a high risk of fire and explosion due to the strong reactivity of lithium.

As an example, when a fire occurs in some of a plurality of battery cells mounted in a battery module or battery pack, a heat transfer or a thermal runaway may occur in the other battery cells due to a chain reaction when the thermal energy or flames generated by the fire is introduced into other adjacent battery cells.

### SUMMARY

The present disclosure has been made to solve the above-mentioned problems occurring in the prior art while advantages achieved by the prior art are maintained intact.

An aspect of the present disclosure provides a battery module that may extinguish a battery cell, in which a fire has occurred, so that a heat transfer to adjacent battery cells may be prevented even in the case of the fire in the battery cell.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes a plurality of battery cells that are arranged in a first direction, and a sensing assembly that is disposed on surfaces of the plurality of battery cells to face the plurality of battery cells, and the sensing assembly includes a busbar that is electrically connected to the plurality of battery cells, a busbar frame that supports the busbar, and a fire extinguishing member that is provided in an area between the busbar frame and the battery cells, and is configured to be exposed in a direction facing the battery cells.

The busbar frame may include an inner surface that faces the battery cells, and the fire extinguishing member may be fixed to the inner surface.

The busbar frame may include a fixing groove formed on the inner surface to be concave, and the fire extinguishing member may include a fire extinguishing material, and a capsule that accommodates the fire extinguishing material, and inserted into the fixing groove.

The capsule may include a capsule body that accommodates the fire extinguishing material, and a protruding rib that protrudes from the capsule body and inserted into the fixing groove.

The fixing groove may extend in a second direction crossing the first direction, and the protruding rib may be inserted into the fixing groove in the direction crossing the first direction.

The protruding rib may include an insertion area that is inserted into the fixing groove to be stopped by the busbar frame, and a connection area that connects the insertion area and the capsule body, and having a smaller width than a width of the insertion area.

A pair of fixing grooves may be provided to be spaced apart from each other in the first direction, a pair of protruding ribs may be provided to be inserted into the pair of fixing grooves, respectively, and each of the pair of protruding ribs may include a connection area that extends from an end of the capsule body in a direction toward the fixing groove, and an insertion area that extends from the connection area in a direction crossing the direction in which the connection area extends, and is stopped by the busbar frame.

The capsule body may have a shape, a width of which decreases as it goes from the inner surface toward the battery cells such that the capsule body guides lead parts of the battery cells.

The battery module may further include an adhesive member that attaches the fire extinguishing member to the inner surface to fix the fire extinguishing member, and the fire extinguishing member may include a fire extinguishing material, and a capsule that accommodates the fire extinguishing material and attached to the inner surface by the adhesive member.

The busbar frame may include a frame body area that extends in the first direction and supporting the busbar, and a guide body area that protrudes from the frame body area toward a space between the plurality of battery cells, and guides lead parts of the battery cells, and the fire extinguishing member may be attached onto guide body surface of the guide body area, which faces the battery cells.

The fire extinguishing member may be filled in areas between the busbar frame and the battery cells.

The busbar frame may include a frame body area that extends in the first direction and supporting the busbar, and a guide body area that protrudes from the frame body area toward spaces between the plurality of battery cells, and guides lead parts of the battery cells, and the fire extinguishing member may be inserted into an area between a lead part of each of the pair of adjacent battery cells, among the plurality of battery cells, and the guide body area.

The fire extinguishing member may include a fire extinguishing material, and a capsule that accommodates the fire extinguishing material and includes a circular, rectangular, or triangular cross section on a cross section that is perpendicular to a second direction crossing the first direction.

According to an aspect of the present disclosure, a battery module includes a plurality of battery cells that is arranged in a first direction, and a sensing assembly that is disposed on surfaces of the plurality of battery cells to face the plurality of battery cells, wherein the sensing assembly includes a busbar that is electrically connected to the plurality of battery cells, a busbar frame that extends in the first direction and supporting the busbar, and a fire extinguishing material that is accommodated in an interior of the busbar frame, the busbar frame includes a frame body area that extends in the first direction and supporting the busbar, a guide body area that protrudes from the frame body area toward a space between the plurality of battery cells and defines an accommodation space accommodating the fire extinguishing material in an interior thereof, and a cover area that is seated on the guide body area to close the accommodation space.

The accommodation space may extend in a second direction crossing the first direction.

According to an aspect of the present disclosure, a battery module is provided. The battery module may comprise a plurality of battery cells and a sensing assembly disposed on surfaces of the plurality of battery cells to face the plurality of battery cells. The sensing assembly may comprise an electrical conductor unit electrically connected to the plurality of battery cells and a fire extinguishing member configured to be exposed in a direction facing the battery cells.

According to an exemplary embodiment, the electrical conductor unit may comprise a busbar, the sensing assembly may comprise a busbar frame configured to support the busbar, the busbar frame may comprise an inner surface facing the battery cells, the fire extinguishing member may be configured to be exposed in a direction facing the battery cells, and the fire extinguishing member may be fixed to the inner surface.

According to an exemplary embodiment, the busbar frame may comprise a fixing groove formed on the inner surface to be concave, and the fire extinguishing member may comprise a fire extinguishing material and a capsule configured to accommodate the fire extinguishing material and be inserted into the fixing groove.

According to an exemplary embodiment, the capsule may comprise a capsule body configured to accommodate the fire extinguishing material and a protruding rib configured to protrude from the capsule body and be inserted into the fixing groove.

According to an exemplary embodiment, the plurality of battery cells may be arranged in a first direction, the fixing groove may extend in a second direction crossing the first direction, and the protruding rib may be inserted into the fixing groove in the second direction crossing the first direction.

According to an exemplary embodiment, the protruding rib may comprise an insertion area inserted into the fixing groove configured to be stopped by the busbar frame and a connection area connecting the insertion area and the capsule body, and having a smaller width than a width of the insertion area.

According to an exemplary embodiment, the battery module may comprise a pair of fixing grooves configured to be spaced apart from each other in a first direction. The plurality of battery cells may be arranged in the first direction and a pair of protruding ribs may be configured to be inserted into the pair of fixing grooves, respectively. Each of the pair of protruding ribs may comprise a connection area extending from an end of the capsule body in a direction toward the fixing groove and an insertion area extending from the connection area in a direction crossing the direction in which the connection area extends, and stopped by the busbar frame.

According to an exemplary embodiment, the capsule body may have a shape, a width of which decreases as it goes from the inner surface toward the battery cells such that the capsule body guides lead parts of the battery cells.

According to an exemplary embodiment, the battery module may comprise an adhesive member configured to attach the fire extinguishing member to the inner surface to fix the fire extinguishing member. The fire extinguishing member may comprise a fire extinguishing material and a capsule configured to accommodate the fire extinguishing material and be attached to the inner surface by the adhesive member.

According to an exemplary embodiment, the plurality of battery cells may be arranged in a first direction, the electrical conductor unit may comprise a busbar, the sensing assembly may comprise a busbar frame configured to support the busbar, the busbar frame may comprise a frame body area extending in the first direction while supporting the busbar and a guide body area protruding from the frame body area toward a space between the plurality of battery cells, the guide body area may be configured to guide lead parts of the battery cells, and the fire extinguishing member may be attached onto a guide body surface of the guide body area, which faces the battery cells.

According to an exemplary embodiment, the electrical conductor unit may comprise a busbar, the sensing assembly may comprise a busbar frame configured to support the busbar, and the fire extinguishing member may be filled in areas between the busbar frame and the battery cells.

According to an exemplary embodiment, the plurality of battery cells may be arranged in a first direction, the electrical conductor unit may comprise a busbar, the sensing assembly may comprise a busbar frame configured to support the busbar, the busbar frame may comprise a frame body area extending in the first direction and supporting the busbar and a guide body area protruding from the frame body area toward spaces between the plurality of battery cells, the guide body area may be configured to guide lead parts of the battery cells, and the fire extinguishing member may be inserted into an area between a lead part of each of the pair of adjacent battery cells, among the plurality of battery cells, and the guide body area.

According to an exemplary embodiment, the plurality of battery cells may be arranged in a first direction, the fire extinguishing member may comprise a fire extinguishing material and a capsule configured to accommodate the fire extinguishing material, and the capsule may comprise a circular, rectangular, or triangular cross section on a cross section being perpendicular to a second direction crossing the first direction.

According to an exemplary embodiment, the electrical conductor unit may comprise a busbar, the sensing assembly may comprise a busbar frame configured to support the busbar, and the fire extinguishing member is provided in an area between the busbar frame and the battery cells.

According to an aspect of the present disclosure, a battery module is provided. The battery module may comprise a plurality of battery cells and a sensing assembly disposed on surfaces of the plurality of battery cells to face the plurality of battery cells. The sensing assembly may comprise an electrical conductor unit electrically connected to the plurality of battery cells and a fire extinguishing material.

According to an exemplary embodiment, the plurality of battery cells may be arranged in a first direction, the electrical conductor unit may comprise a busbar, the sensing assembly may comprise a busbar frame extending in the first direction and configured to support the busbar, and the busbar frame may comprise a frame body area extending in the first direction and supporting the busbar, a guide body area protruding from the frame body area toward a space between the plurality of battery cells and defining an accommodation space accommodating the fire extinguishing material in an interior thereof, and a cover area seated on the guide body area configured to close the accommodation space.

According to an exemplary embodiment, the accommodation space may extend in a second direction crossing the first direction.

According to an aspect of the present disclosure, a battery module is provided. The battery module may comprise a sensing assembly disposed on surfaces of a plurality of battery cells to face the plurality of battery cells. The sensing assembly may comprise an electrical conductor unit electrically connected to the plurality of battery cells and a fire extinguishing member.

According to an exemplary embodiment, the electrical conductor unit may comprise a busbar, the sensing assembly may comprise a busbar frame configured to support the busbar, the busbar frame may comprise an inner surface facing the battery cells, and the fire extinguishing member may be fixed to the inner surface.

According to an exemplary embodiment, the busbar frame may comprise a fixing groove formed on the inner surface to be concave, and the fire extinguishing member may comprise a fire extinguishing material and a capsule configured to accommodate the fire extinguishing material and be inserted into the fixing groove.

According to an exemplary embodiment, the fire extinguishing member may be provided in an area between the busbar frame and the battery cells.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a perspective view of a battery module, according to an exemplary embodiment of the present disclosure.

FIG. 2 illustrates a perspective view of a sensing assembly of a battery module, according to an exemplary embodiment of the present disclosure.

FIG. 3 illustrates a transverse cross-sectional view of a portion of a battery module, according to an exemplary embodiment of the present disclosure.

FIG. 4 illustrates a transverse cross-sectional view of a fire extinguishing member and a busbar frame of a battery module, according to an exemplary embodiment of the present disclosure.

FIG. 5 illustrates a transverse cross-sectional view of a fire extinguishing member and a busbar frame of a battery module, according to an exemplary embodiment of the present disclosure.

FIG. 6 illustrates a transverse cross-sectional view of a fire extinguishing member and a busbar frame of a battery module, according to an exemplary embodiment of the present disclosure.

FIG. 7 illustrates a transverse cross-sectional view of a fire extinguishing member, an adhesive member, and a busbar frame of a battery module, according to an exemplary embodiment of the present disclosure.

FIG. 8 illustrates a perspective view of a sensing assembly, according to an exemplary embodiment of the present disclosure.

FIG. 9 illustrates a transverse cross-sectional view of a fire extinguishing member and a busbar frame of a battery module, according to an exemplary embodiment of the present disclosure.

FIG. 10 illustrates a perspective view of a sensing assembly, according to an exemplary embodiment of the present disclosure.

FIG. 11 illustrates a transverse cross-sectional view of a fire extinguishing member and a busbar frame of a battery module, according to an exemplary embodiment of the present disclosure.

FIG. 12 illustrates a perspective view of a battery module, according to an exemplary embodiment of the present disclosure.

FIG. 13 illustrates a transverse cross-sectional view of a fire extinguishing member and a busbar frame of a battery module, according to an exemplary embodiment of the present disclosure.

FIG. 14 illustrates a perspective view of a sensing assembly, according to an exemplary embodiment of the present disclosure.

FIG. 15 illustrates a transverse cross-sectional view of a fire extinguishing member and a busbar frame of a battery module, according to an exemplary embodiment of the present disclosure.

FIG. 16 illustrates a transverse cross-sectional view of a portion of a battery module, according to an exemplary embodiment of the present disclosure.

FIG. 17 illustrates a transverse cross-sectional view of a portion of a battery module, according to an exemplary embodiment of the present disclosure.

FIG. 18 illustrates a plan view of a battery pack, to which a battery module is applied, according to an exemplary embodiment of the present disclosure.

FIG. 19 illustrates a view of a venting device of the battery pack illustrated in FIG. 18, according to an exemplary embodiment of the present disclosure.

### DETAILED DESCRIPTION

Hereinafter, some embodiments of the present disclosure will be described in detail with reference to the accompanying drawings. In the drawings, the same reference numerals will be used throughout to designate the same or equivalent components. In describing embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one component from another component, but do not limit the corresponding components irrespective of the nature, order, or priority of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

In addition, terms such as first, second, and the like used herein may be used to describe various components, but the various components are not limited by these terms. The terms are used solely for the purpose of distinguishing one component from other components. For example, a first component may be referred to as a second component, and a second component may also be referred to as a first component, without departing from the scope of rights according to the inventive concepts of the present disclosure.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

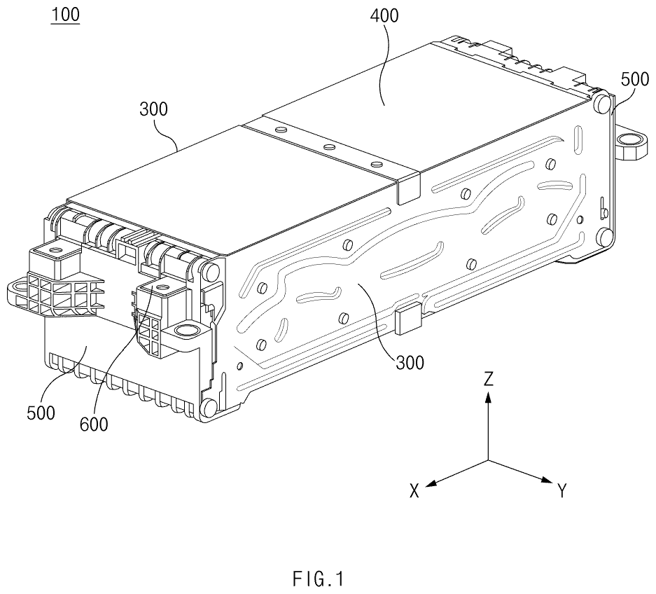

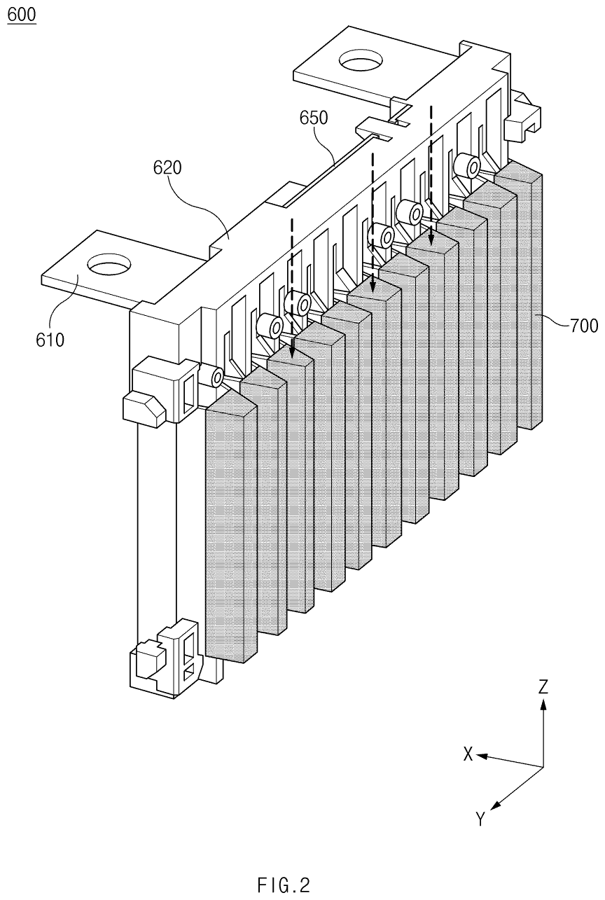

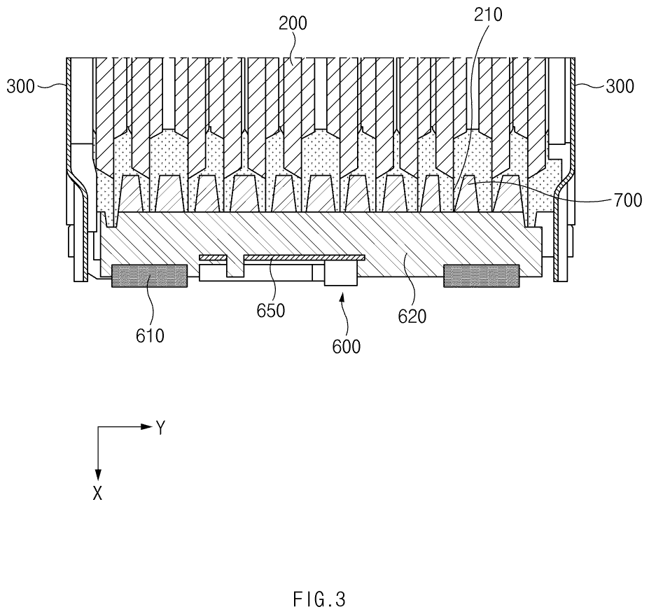

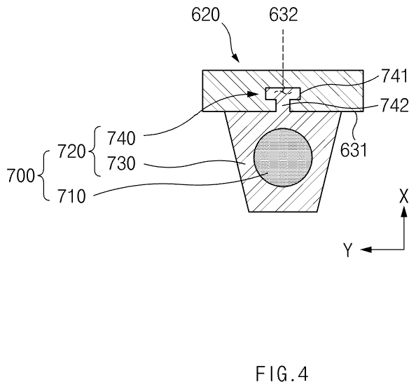

FIG. 1 illustrates a perspective view of a battery module, according to an exemplary embodiment of the present disclosure. FIG. 2 illustrates a perspective view of a sensing assembly of a battery module, according to an exemplary embodiment of the present disclosure. FIG. 3 illustrates a transverse cross-sectional view of a portion of a battery module, according to an exemplary embodiment of the present disclosure. FIG. 4 illustrates a transverse cross-sectional view of a fire extinguishing member and a busbar frame of a battery module, according to an exemplary embodiment of the present disclosure.

Referring to FIGS. 1 to 4, a battery module 100 may comprise a plurality of battery cells 200, one or more end plates 300, a module cover 400, one or more sensing covers 500, and a sensing assembly 600.

The plurality of battery cells 200 may be configured to extend in a first direction (the X direction or an opposite direction to the X direction), and may be arranged in a second direction (the Y direction or an opposite direction to the Y direction). The plurality of battery cells 200 may extend such that the first direction (the X direction or an opposite direction to the X direction) becomes a lengthwise direction thereof. The first direction (the X direction or an opposite direction to the X direction) and the second direction (the Y direction or an opposite direction to the Y direction) may be perpendicular to each other.

Each of the plurality of battery cells 200 may comprise lead parts 210. The lead part of each of the plurality of battery cells 200 may be configured to extend toward the sensing assembly 600. The battery cells 200 may be configured to be electrically connected to the sensing assembly 600 through the lead parts 210.

Surface-pressure members or cooling plates may be provided between the plurality of battery cells 200. The surface-pressure members may be configured to apply a surface pressure to the battery cells 200. The cooling plates may be a configuration for absorbing heat from the battery cells 200 and cooling the battery cells 200 while contacting the plurality of battery cells 200.

A pair of end plates 300 may be provided. The pair of end plates 300 may be configured to be disposed on opposite sides of the plurality of battery cells 200 in the second direction (the Y direction or an opposite direction to the Y direction). The pair of end plates 300 may be configured to support the plurality of battery cells 200 that are disposed between the pair of end plates 300 while accommodating them.

The pair of end plates 300 may be configured to apply a surface pressure to the plurality of battery cells 200 to prevent swelling of the battery cells 200.

The module cover 400 may be configured to cover the plurality of battery cells 200. The module cover 400 may be configured to be supported by the pair of end plates 300 or the pair of sensing covers 500. On the module cover 400, a clamp member may be provided, the clamp member being configured to apply a force to the pair of end plates 300 so that the pair of end plates 300 are pressed toward each other may be provided.

A pair of sensing covers 500 may be provided and configured to be connected to the pair of end plates 300, respectively. The sensing covers 500 may be configured to cover one surface of the sensing assembly 600. The sensing assembly 600 may be provided between the sensing covers 500 and the battery cells 200.

The sensing assembly 600 may be configured to be disposed on surfaces of the plurality of battery cells 200 to face the plurality of battery cells 200.

A pair of sensing assemblies 600 may be provided and configured to be disposed on opposite sides of the plurality of battery cells 200 in the first direction (the X direction or an opposite direction to the X direction). The sensing assembly 600 may be configured to be disposed on opposite sides of the plurality of battery cells 200 in the first direction (the X direction or an opposite direction to the X direction) and may cover an area between the pair of end plates 300.

The sensing assembly 600 may comprise a busbar 610 that is configured to be electrically connected to each of the plurality of battery cells 200, a busbar frame 620 that is configured to support the busbar 610, and a sensing board 650 that is configured to be mounted on the busbar frame 620. It is noted that, while the term busbar 610 is used, the embodiments of the present disclosure are not limited thereto, and other suitable electrical conductor units may be incorporated while maintaining the spirit and functionality of the present disclosure.

The busbar 610 may be configured to be electrically connected to the lead parts 210. A plurality of busbars 610 may be provided and configured to be spaced apart from each other along the second direction (the Y direction or an opposite direction to the Y direction).

The busbar frame 620 may be configured to extend in the second direction (the Y direction or the opposite direction to the Y direction) to support the plurality of busbars 610. The busbar frame 620 may be configured to extend to face the plurality of battery cells 200, and the busbar frame 620 may be covered by the sensing covers 500.

The sensing assembly 600, according to an exemplary embodiment of the present disclosure, may comprise a structure configured to guide the lead parts 210 on an inner surface 631 of the busbar frame 620, and a fire extinguishing member 700 may be mounted thereon.

In other words, the battery module 100, according to an exemplary embodiment of the present disclosure, may comprise the fire extinguishing member 700 that is provided in an area between the busbar frame 620 and the battery cell 200 and may be formed to be exposed in a direction that faces the battery cells 200.

The fire extinguishing member 700 may comprise a fire extinguishing material 710, and a capsule 720 that is configured to accommodate the fire extinguishing material 710. The fire extinguishing member 700 may comprise a fire extinguishing agent in the form of capsules that contain calcium carbonate or halogen compounds in a powder form, and may comprise a material that discharges a fire extinguishing gas, such as carbon dioxide, at a high temperature.

The fire extinguishing material 710 may be formed of substances, such as ammonium phosphate, sodium bicarbonate, potassium bicarbonate, ammonium phosphate, a material containing potassium (K), ammonium carbonate, potassium carbonate, magnesium carbonate, or nitrogen, and the present disclosure is not limited thereto, and may be contained in the form of a solid, such as powder, a liquid, or a gas, such as carbon dioxide.

The capsule 720 may be formed of a solid and may be formed to be physically broken, melted, or phase-changed at a specific temperature or more.

The capsule 720 may be configured to accommodate the fire extinguishing material 710, and may be disposed between the busbar frame 620 and the battery cells 200. The fire extinguishing material 710 may be accommodated in an interior of the capsule 720 and, when a fire occurs in a battery cell 200, may be configured to be discharged to the outside of the capsule 720 to extinguish the battery cell 200.

As such, because the fire extinguishing member 700 is disposed between the busbar frame 620 and the battery cell 200, the battery cell 200 may be extinguished in a shorter time compared to a structure, in which the fire extinguishing member is disposed between the busbar frame and the sensing covers.

Meanwhile, the fire extinguishing member 700 may be configured to be fixed to an inner surface 631 of the busbar frame 620, which faces the battery cell 200.

Specifically, the busbar frame 620 may define a fixing groove 632 that is formed on the inner surface 631 to be concave. The fixing groove 632 may be configured to extend in a third direction (the Z direction or an opposite direction to the Z direction). The fixing groove 632 may have a shape that is opened in an opposite direction to the battery cell 200 from the inner surface 631.

The capsule 720 may comprise a capsule body 730 that is configured to accommodate the fire extinguishing material 710 and a protruding rib 740 that is configured to protrude from the capsule body 730 toward the busbar frame 620.

In an interior of the capsule body 730, a space configured to extend in the third direction (the Z direction or an opposite direction to the Z direction) and to accommodate the fire extinguishing material 710 may be provided. As illustrated in FIG. 4, this space may have a circular cross section on a cross section that is perpendicular to the third direction (the Z direction or the opposite direction to the Z direction), but the present disclosure is not limited thereto.

The protruding rib 740 may be configured to protrude from the capsule body 730 and may be configured to be inserted into the fixing groove 632. The protruding rib 740, like the capsule body 730, may be configured to extend in the third direction (the Z direction or the opposite direction to the Z direction).

The protruding rib 740 may comprise an insertion area 741 and a connection area 742. The connection area 742 may comprise a portion of the protruding rib 740, which may be configured to protrude from the capsule body 730 toward the busbar frame 620, and the insertion area 741 may comprise a portion of the protruding rib 740, which may be configured to extend to opposite sides from the connection area 742.

In other words, the protruding rib 740 may comprise an insertion area 741 that is configured to be inserted into the fixing groove 632 and stopped by the busbar frame 620, and a connection area 742 that is configured to connect the insertion area 741 to the capsule body 730 and may have a smaller width than the insertion area 741 in the second direction (the Y direction or the opposite direction to the Y direction).

The fixing groove 632 may also comprise an insertion space, into which the insertion area 741 is inserted, and a connection space, into which the connection area 742 is inserted, and the width of the connection space in the second direction (the Y direction or the opposite direction to the Y direction) may be smaller than the width of the insertion space in the same direction.

With this structure, the protruding rib 740 may be configured to be inserted into the fixing groove 632 in the third direction (the Z direction or the opposite direction to the Z direction), and when the protruding rib 740 is fully inserted into the fixing groove 632, the capsule 720 may be configured to be inserted into the fixing groove 632.

In this manner, when the protruding rib 740 is fully inserted into the fixing groove 632, the capsule 720 may be prevented from being extracted from the busbar frame 620 in a direction other than one side (the Z direction) in the third direction, and thus the fire extinguishing member 700 may be stably fixed in position in an interior of the battery module 100.

In addition, the fire extinguishing members 700 may be disposed between the lead parts 210 of the plurality of battery cells 200, and may guide the positions of the lead parts 210.

The lead parts 210 may be configured to be moved along the second direction (the Y direction or an opposite direction to the Y direction), and because the fire extinguishing members 700 are located on opposite sides of the lead part 210, movement of the lead part 210 may be restricted. Accordingly, the electrical connection between the battery cell 200 and the busbar 610 may be stabilized.

For example, the capsule body 730 may have a shape, a width of which becomes smaller as it goes toward the battery cells 200 from the inner surface 631 of the busbar frame 620 to guide the lead part 210 of the battery cell 200.

This is because the lead part 210 of the battery cell 200 may be allowed to be moved freely as the length that extends toward the busbar frame 620 increases, but as the ends of the lead parts 210 are guided by the capsule body 730, the movement of the lead parts 210 may be restricted, whereby the electrical connection between the battery cell 200 and the busbar 610 may be stabilized.

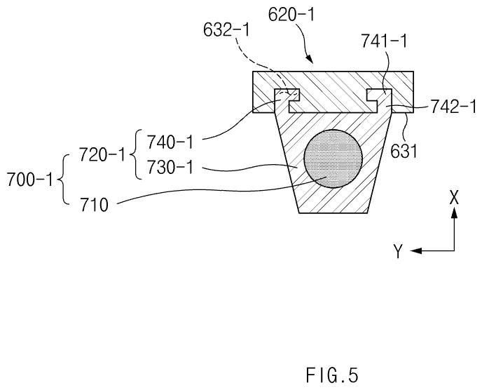

FIG. 5 illustrates a transverse cross-sectional view of a fire extinguishing member and a busbar frame of a battery module, according to an exemplary embodiment of the present disclosure.

Referring to FIG. 5, a fire extinguishing member 700-1 and a busbar frame 620-1, according to an exemplary embodiment of the present disclosure, may have shapes that are different from those of the fire extinguishing member 700 and the busbar frame 620 illustrated in FIG. 4.

For the description of the components other than the structures of the fire extinguishing member 700-1 and the busbar frame 620-1 illustrated in FIG. 5, the description made in FIGS. 1 to 4 will be used.

A fixing groove 632-1, according to an exemplary embodiment of the present disclosure, may be formed on an inner surface 631 of the busbar frame 620-1, which faces the battery cell 200 (see FIG. 3), to be concave, and a pair of fixing grooves 632-1 for a single fire extinguishing member 700-1 may be provided.

For example, the pair of fixing grooves 632-1 may be provided and configured to be spaced apart from each other in the second direction (the Y direction or an opposite direction to the Y direction). Each of the pair of fixing grooves 632-1 may comprise an insertion space and a connection space. The connection space of the fixing groove 632-1 may comprise a space that extends from the inner surface 631-1, and the insertion space of the fixing groove 632-1 may comprise a space that extends from the connection space toward each other.

A pair of protruding ribs 740-1 may be provided and configured to be inserted into the pair of fixing grooves 632-1, respectively. The pair of protruding ribs 740-1 may be configured to extend to be symmetrical to each other from opposite ends of the capsule body 730-1 in the second direction (the Y direction or the opposite direction to the Y direction).

The pair of protruding ribs 740-1 may comprise connection areas 742-1 that are configured to extend in parallel from opposite ends of the capsule body 730-1 in the second direction (the Y direction or an opposite direction to the Y direction) toward the fixing groove 632-1, and insertion areas 741-1 that are configured to extend from the connection area 742-1 in the second direction (the Y direction or the opposite direction to the Y direction) that is perpendicular to the extension direction of the connection areas 742-1, and are stopped by the busbar frame 620-1.

With this structure, the pair of protruding ribs 740-1 may be movable only through the third direction (the Z direction or an opposite direction to the Z direction) with respect to the busbar frame 620-1.

Accordingly, the protruding ribs 740-1 may be configured to inserted into the fixing grooves 632-1 in the third direction (the Z direction or the opposite direction to the Z direction), and thus, the capsule 720-1 may be stably fixed in position by the busbar frame 620-1.

Like FIG. 4, the capsule body 730-1 may have a shape, a width of which becomes smaller as it goes toward the battery cells 200 to guide the lead parts 210 of the battery cells 200 from the inner surface 631 of the busbar frame 620-1. The effects are as described in FIG. 4.

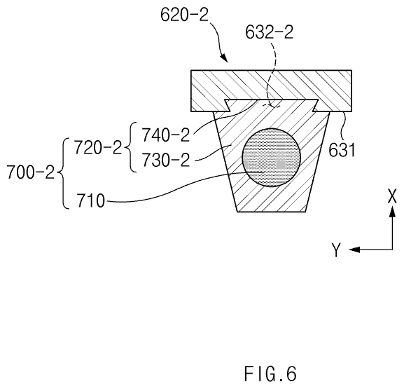

FIG. 6 illustrates a transverse cross-sectional view of a fire extinguishing member and a busbar frame of a battery module, according to an exemplary embodiment of the present disclosure.

Referring to FIG. 6, a fire extinguishing member 700-2 and a busbar frame 620-2, according to an exemplary embodiment of the present disclosure, may have shapes that are different from those of the fire extinguishing member 700 and the busbar frame 620 illustrated in FIG. 4.

For the description of the components other than the structures of the fire extinguishing member 700-2 and the busbar frame 620-2 illustrated in FIG. 6, the description made in FIGS. 1 to 4 will be used.

A fixing groove 632-2, according to an exemplary embodiment of the present disclosure, may be formed on an inner surface 631 of the busbar frame 620-2, which faces the battery cells 200 (see FIG. 3) to be concave.

The protruding rib 740-2 may be provided and configured to be inserted into the fixing groove 632-2. In particular, the protruding rib 740-2 may be formed and configured to be inserted into the fixing groove 632-2 and be stopped by the busbar frame 620-2.

For example, the protruding rib 740-2 may have a shape, a width of which becomes smaller as it goes toward the battery cells 200 (see FIG. 3) from the fixing groove 632-2, but the present disclosure is not limited thereto.

Accordingly, the protruding ribs 740-2 may be configured to be inserted into the fixing grooves 632-2 in the third direction (the Z direction or the opposite direction to the Z direction), and thus, the capsule 720-2 may be stably fixed in position by the busbar frame 620-2.

Like FIG. 4, the capsule body 730-2 may have a shape, a width of which becomes smaller as it goes toward the battery cells 200 to guide the lead parts 210 of the battery cells 200 from the inner surface 631 of the busbar frame 620-2. The effects are as described in FIG. 4.

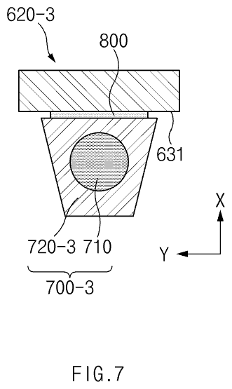

FIG. 7 illustrates a transverse cross-sectional view of a fire extinguishing member, an adhesive member, and a busbar frame of a battery module, according to an exemplary embodiment of the present disclosure.

Referring to FIG. 7, a fire extinguishing member 700-3 and a busbar frame 620-3, according to an exemplary embodiment of the present disclosure, may have shapes that are different from those of the fire extinguishing member 700 and the busbar frame 620 illustrated in FIG. 4.

For the description of the components other than the structures of the fire extinguishing member 700-3, and an adhesive member 800, and the busbar frame 620-3 illustrated in FIG. 7, the description made in FIGS. 1 to 4 will be used.

Unlike FIG. 4, the busbar frame 620-3, according to an exemplary embodiment of the present disclosure, may not define a fixing groove 632. Furthermore, the capsule 720-3 of the fire extinguishing member 700-3, according to an exemplary embodiment of the present disclosure, may not comprise a protruding rib 740.

Instead, the fire extinguishing member 700-3 may be configured to be attached onto an inner surface 631 of the busbar frame 620-3, which faces the battery cell 200 (see FIG. 3), by the adhesive member 800. The adhesive member 800 may comprise any material having adhesiveness.

In other words, unlike FIGS. 4, 5, and 6, the fire extinguishing member 700-3, according to an exemplary embodiment of the present disclosure, may not comprise a structure that is stopped by the busbar frame 620-3, and may be fixed to the inner surface 631 by the adhesive member 800.

That is, the sensing assembly, according to an exemplary embodiment of the present disclosure, may further comprise an adhesive member 800 that is configured to fix the fire extinguishing member 700-3 by attaching it onto the inner surface 631.

For example, the fire extinguishing member 700-3 may comprise the fire extinguishing material 710, and a capsule 720-3 that is configured to accommodate the fire extinguishing material 710 and is configured to be attached to the inner surface 631 by the adhesive member 800.

The capsule 720-3 may be configured to be stably fixed in position by the busbar frame 620-3 by means of the adhesive member 800 in the third direction (the Z direction or an opposite direction to the Z direction).

The capsule 720-3 may have a shape, a width of which becomes smaller as it goes toward the battery cells 200 from the inner surface 631 of the busbar frame 620 to guide the lead part 210 (see FIG. 3) of the battery cell 200. The effects are as described in FIG. 4.

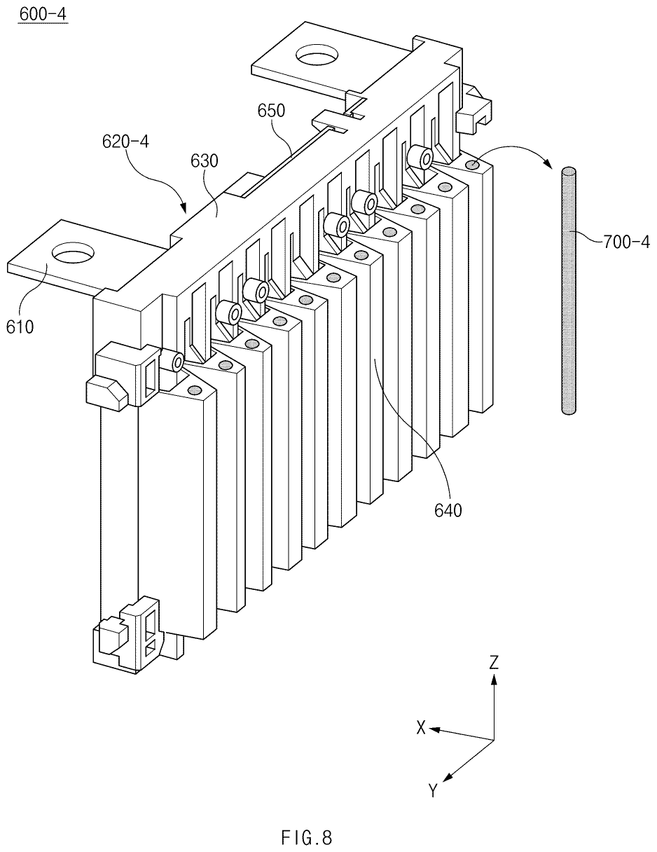

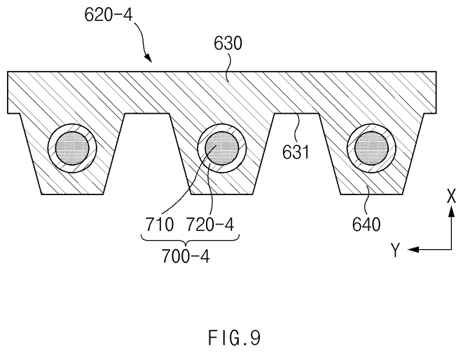

FIG. 8 illustrates a perspective view of a sensing assembly, according to an exemplary embodiment of the present disclosure. FIG. 9 illustrates a transverse cross-sectional view of a fire extinguishing member and a busbar frame of a battery module, according to an exemplary embodiment of the present disclosure.

Referring to FIGS. 8 and 9, a sensing assembly 600-4, according to an exemplary embodiment of the present disclosure, may comprise a busbar 610, a busbar frame 620-4, a sensing board 650, and a fire extinguishing member 700-4.

For a description of the sensing assembly 600-4, according to an exemplary embodiment of the present disclosure, the description of the busbar 610 and the sensing board 650 of the sensing assembly 600 illustrated in FIG. 2 will be used.

Unlike the busbar frame 620, the busbar frame 620-4 may be configured to accommodate the fire extinguishing member 700-4 or the fire extinguishing material 710 in an interior thereof.

The busbar frame 620-4 may comprise a frame body area 630 that extends in the second direction (the Y direction or an opposite direction to the Y direction) while supporting the busbar 610, and a guide body area 640 that protrudes from an inner surface 631 of the frame body area 630 toward spaces between the plurality of battery cells 200 (see FIG. 3).

The guide body area 640 may be configured to guide the lead part 210 of the battery cell 200. The guide body area 640 may be configured to define an accommodation space that extends in the third direction (the Z direction or an opposite direction to the Z direction).

The fire extinguishing member 700-4 or the fire extinguishing material 710 itself may be configured to be inserted into the accommodation space of the guide body area 640.

That is, the fire extinguishing member 700-4 or the fire extinguishing material 710, according to an exemplary embodiment of the present disclosure, may have a structure that is accommodated by the guide body area 640 rather than a structure that is fixed to the inner surface 631.

The fire extinguishing member 700-4 may comprise a fire extinguishing material 710, and a capsule 720-4 that is configured to accommodate the fire extinguishing material 710. The capsule 720-4 may have a cylindrical shape, but the present disclosure is not limited thereto. Furthermore, according to an exemplary embodiment, only the fire extinguishing material 710 itself may be accommodated in the accommodation space of the guide body area 640.

For example, the guide body area 640 may have a shape, a width of which becomes smaller as it goes toward the battery cell 200 from the inner surface 631. The guide body area 640, like in the principle of the capsule body 730 in FIG. 4, may be configured to guide the lead part 210 of the battery cell 200.

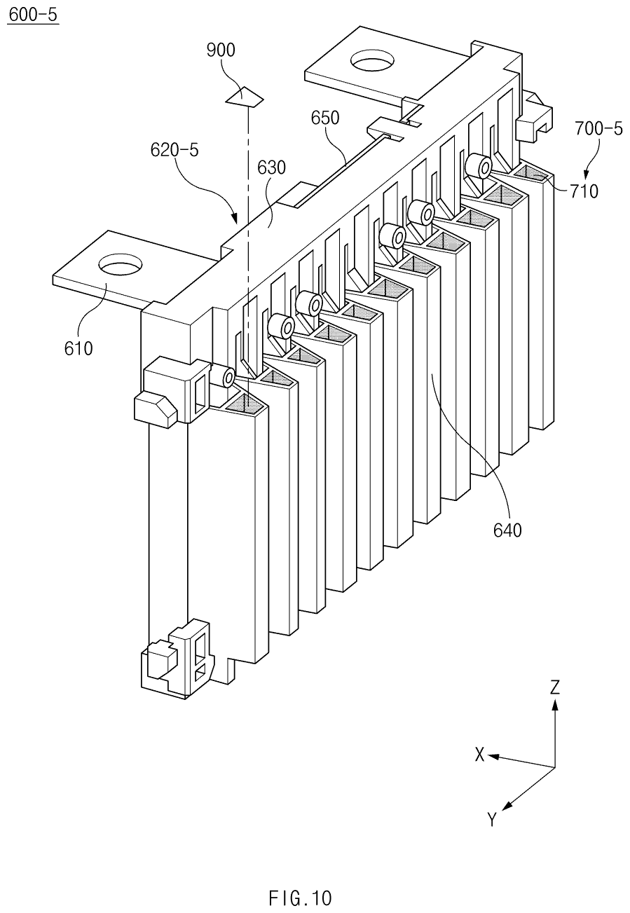

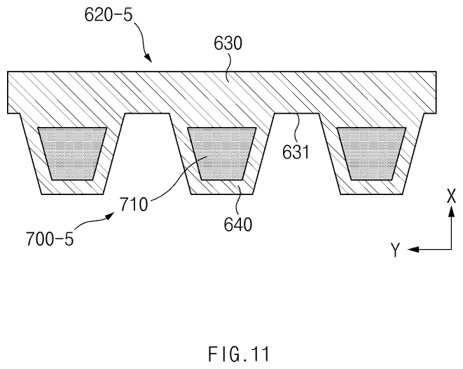

FIG. 10 illustrates a perspective view of a sensing assembly, according to an exemplary embodiment of the present disclosure. FIG. 11 illustrates a transverse cross-sectional view of a fire extinguishing member and a busbar frame of a battery module, according to an exemplary embodiment of the present disclosure.

Referring to FIGS. 10 and 11, a sensing assembly 600,-5, according to an exemplary embodiment of the present disclosure may comprise a busbar 610, a busbar frame 620-5, a sensing board 650, and a fire extinguishing member 700-5.

For a description of the sensing assembly 600-5 according to another embodiment of the present disclosure, the description of the busbar 610 and the sensing board 650 of the sensing assembly 600 illustrated in FIG. 2 will be used.

Unlike the busbar frame 620, the busbar frame 620-5 may be configured to accommodate the fire extinguishing material 710 or the fire extinguishing member 700-5 in an interior thereof.

The busbar frame 620-5 may comprise a frame body area 630 that extends in the second direction (the Y direction or an opposite direction to the Y direction) while supporting the busbar 610, a guide body area 640 that protrudes from an inner surface 631 of the frame body area 630 toward spaces between the plurality of battery cells 200 (see FIG. 3), and a cover area 900 that is seated on the guide body area 640.

The guide body area 640 may be configured to guide the lead part 210 of the battery cell 200. The guide body area 640 may be configured to define an accommodation space that extends in the third direction (the Z direction or an opposite direction to the Z direction).

The fire extinguishing member 700-5 or the fire extinguishing material 710 itself may be configured to be inserted into the accommodation space of the guide body area 640, and the accommodation space of the guide body area 640 may be covered by the cover area 900.

That is, the fire extinguishing member 700-5 or the fire extinguishing material 710, according to an exemplary embodiment of the present disclosure, may have a structure that is configured to be accommodated by the guide body area 640 and is covered by the cover area 900 rather than a structure that is fixed to the inner surface 631.

The fire extinguishing member 700-5 may comprise a fire extinguishing material 710, and a capsule 720-4 that is configured to accommodate the fire extinguishing material 710. The capsule 720-4 may have a cylindrical shape, but the present disclosure is not limited thereto. Furthermore, only the fire extinguishing material 710 itself may be configured to be accommodated in the accommodation space of the guide body area 640.

The cover area 900 may be configured to be seated on the guide body area 640 to close the accommodation space. The cover area 900 may be fixed to the guide body area 640 to cover the fire extinguishing member 700-5 or the fire extinguishing material 710 when the battery cell 200 is operated normally, but when a fire occurs in the battery cell 200, the cover area 900 may be separated from the guide body area 640 to guide the fire extinguishing material 710 such that it is sprayed toward the battery cell 200.

For example, when a fire occurs in the battery cell 200, the fire extinguishing material 710, a temperature of which has been increased, may be configured to expand within the accommodation space of the guide body area 640 to separate the cover area 900 from the guide body area 640.

For example, the guide body area 640 may have a shape, a width of which becomes smaller as it goes toward the battery cell 200 from the inner surface 631. The guide body area 640, like in the principle of the capsule body 730 in FIG. 4, may be configured to guide the lead part 210 of the battery cell 200.

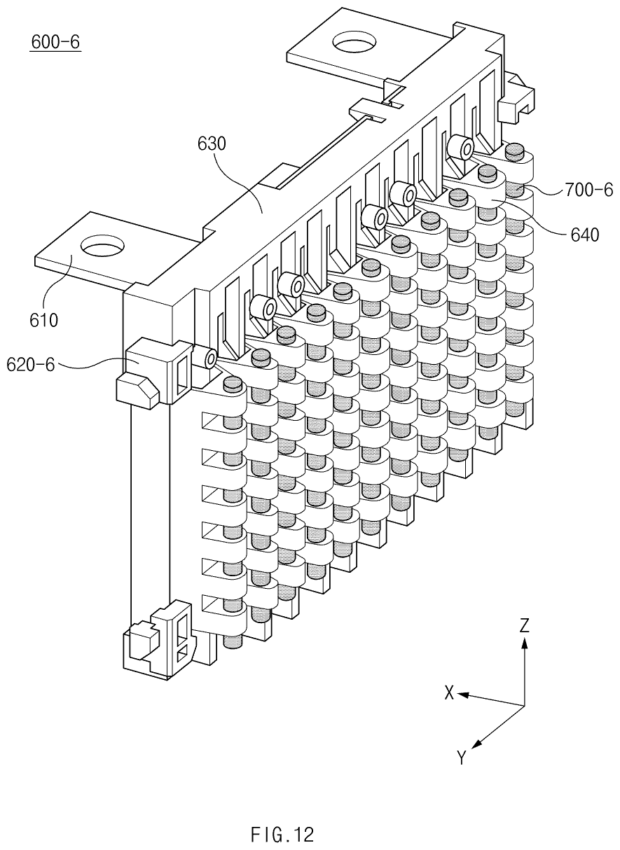

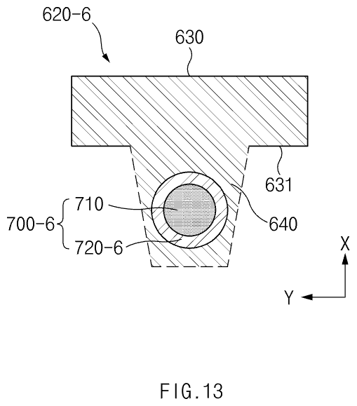

FIG. 12 illustrates a perspective view of a battery module, according to an exemplary embodiment of the present disclosure. FIG. 13 illustrates a transverse cross-sectional view of a fire extinguishing member and a busbar frame of a battery module, according to an embodiment of the present disclosure.

Referring to FIGS. 12 and 13, a sensing assembly 600-6 may comprise a busbar 610, a busbar frame 620-6, and a fire extinguishing member 700-6.

The busbar 610 may be configured to be attached on a surface of the busbar frame 620-6, which that faces the outside.

The busbar frame 620-5 may comprise a frame body area 630 that extends in the second direction (the Y direction or an opposite direction to the Y direction) to support the busbar 610, and a guide body area 640 that protrudes from an inner surface 631 of the frame body area 630 toward spaces between the plurality of battery cells 200 (see FIG. 3).

The guide body area 640 may have a shape, a width of which becomes smaller as it goes toward the battery cells 200 from the inner surface 631 to guide the lead part 210 of the battery cell 200. The guide body area 640 may be configured to define an accommodation space that extends in the third direction (the Z direction or an opposite direction to the Z direction).

The fire extinguishing member 700-6 may be configured to be accommodated in the accommodation space of the guide body area 640. An outer surface of the fire extinguishing member 700-6 may comprise a portion that is contacted by the guide body area 640, and a portion that is exposed to the battery cell 200.

A portion of the fire extinguishing member 700-6 may be fixed by the guide body area 640, and another portion thereof may be exposed toward the battery cell 200.

In other words, the sensing assembly 600-6, according to an exemplary embodiment of the present disclosure, may comprise the fire extinguishing member 700-6 that is provided in an area between the busbar frame 620-6 and the battery cell 200 and is formed to be exposed in a direction that faces the battery cells 200.

The fire extinguishing member 700-6 may comprise the fire extinguishing material 710, and a capsule 720-6 that contains the fire extinguishing material 710 and is seated on the guide body area 640 to be fixed in position.

With this structure, when a fire occurs in the battery cell 200, the fire extinguishing member 700-6 may be configured to immediately discharge the fire extinguishing material 710 accommodated in the capsule 720-6 toward the battery cell 200, so that heat transfer in the interior of the battery module 100 (see FIG. 1) may be prevented.

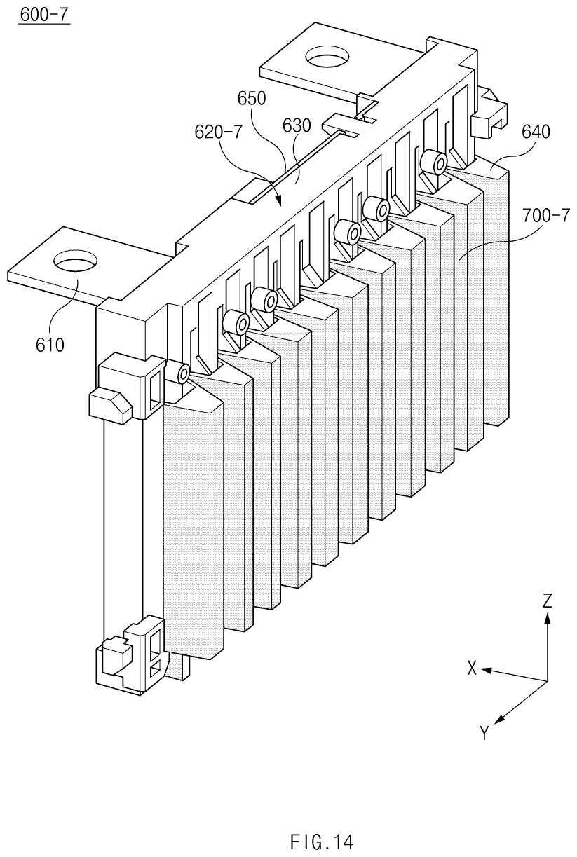

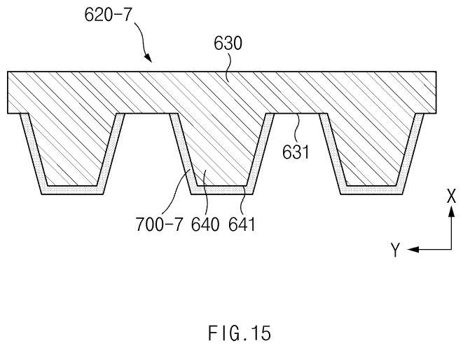

FIG. 14 illustrates a perspective view of a sensing assembly, according to an exemplary embodiment of the present disclosure. FIG. 15 illustrates a transverse cross-sectional view of a fire extinguishing member and a busbar frame of a battery module, according to an exemplary embodiment of the present disclosure.

Referring to FIGS. 14 and 15, a sensing assembly 600-7 may comprise a busbar 610, a busbar frame 620-7 that is configured to support the busbar 610, and a fire extinguishing member 700-7.

The busbar 610 may be configured to be attached on a surface of the busbar frame 620-7, that which faces the outside.

The busbar frame 620-7 may comprise a frame body area 630 that extends in the second direction (the Y direction or an opposite direction to the Y direction) to support the busbar 610, and a guide body area 640 that protrudes from an inner surface 631 of the frame body area 630 toward spaces between the plurality of battery cells 200 (see FIG. 3).

The guide body area 640 may have a shape, a width of which becomes smaller as it goes toward the battery cells 200 from the inner surface 631 to guide the lead part 210 of the battery cell 200.

The guide body area 640 may comprise a guide surface 641 as a remaining boundary surface other than the inner surface 631. The guide surface 641 may be a portion of the guide body area 640, which faces the battery cell 200.

The fire extinguishing member 700-7 may be configured to be attached to the guide surface 641. The fire extinguishing member 700-7 may comprise a fire extinguishing agent in the form that contain calcium carbonate or halogen compounds in a powder form, and may comprise a material that discharges a fire extinguishing gas, such as carbon dioxide, at a high temperature.

The fire extinguishing material 710 may be formed of substances, such as ammonium phosphate, sodium bicarbonate, potassium bicarbonate, ammonium phosphate, a material containing potassium (K), ammonium carbonate, potassium carbonate, magnesium carbonate, or nitrogen, and the present disclosure is not limited thereto, and may be contained in the form of a solid, such as powder, a liquid, or a gas, such as carbon dioxide.

The fire extinguishing member 700-7 may comprise a cover sheet that is attached to one surface of the fire extinguishing material, which faces the battery cell 200. The cover sheet may be formed of a solid and may be formed to be physically broken, melted, or phase-changed at a specific temperature or more.

The fire extinguishing member 700-7 may be formed in a sheet form by mixing the above-described fire extinguishing material 710 based on a silicon pad, epoxy pad, or polyurethane pad that is a base of the sheet.

Even with this structure, the sensing assembly 600-7 may comprise the fire extinguishing member 700-7 that is provided in an area between the busbar frame 620-7 and the battery cell 200 and may be formed to be exposed in a direction that faces the battery cells 200.

When a fire occurs in the battery cell 200, the fire extinguishing member 700-7 may be configured to immediately extinguish the battery cell 200, so that heat transfer in the interior of the battery module 100 (see FIG. 1) may be prevented.

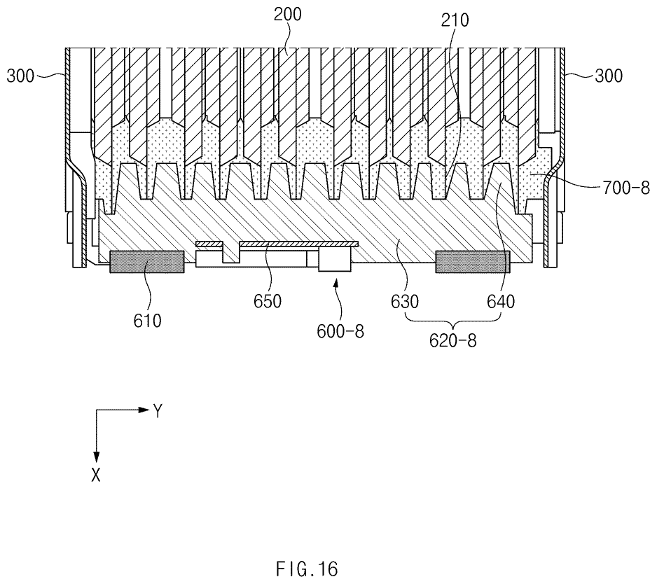

FIG. 16 illustrates a transverse cross-sectional view of a portion of a battery module, according to an exemplary embodiment of the present disclosure.

Referring to FIG. 16, a sensing assembly 600-8 may comprise a busbar 610, a busbar frame 620-8, a sensing board 650, and a fire extinguishing member 700-8.

The busbar 610 may be configured to be electrically connected to the lead part 210 of each of the plurality of battery cells 200.

The busbar frame 620-8 may comprise a frame body area 630 that extends in the second direction (the Y direction or an opposite direction to the Y direction) to support the busbar 610, and a guide body area 640 that protrudes from the frame body area 630 toward spaces between the plurality of battery cells 200.

The guide body area 640 may have a shape, a width of which becomes smaller as it goes toward the battery cells 200 from the frame body area 630 to guide the lead part 210 of each of the plurality of battery cells 200.

The fire extinguishing member 700-8 may not be in the form of a capsule, but may be filled in an area between the busbar frame 620-8 and the battery cell 200 as a fire extinguishing material in a gel or liquid state having adhesiveness. For the material of the fire extinguishing member 700-8, the above-described fire extinguishing material may be used, and it is sufficient as long as it is any material that is suitable for extinguishing the battery cell 200.

The fire extinguishing material 710 may be formed of substances, such as ammonium phosphate, sodium bicarbonate, potassium bicarbonate, ammonium phosphate, a material containing potassium (K), ammonium carbonate, potassium carbonate, magnesium carbonate, or nitrogen, and the present disclosure is not limited thereto, and may be contained in the form of a solid, such as powder, a liquid, or a gas, such as carbon dioxide.

The fire extinguishing member 700-8 may be formed in the form of a gel or a liquid by mixing the above-described fire extinguishing material 710 with a base material for the gel.

Even with this structure, the sensing assembly 600-8 may comprise the fire extinguishing member 700-8 that is provided in an area between the busbar frame 620-8 and the battery cell 200 and may be formed to be exposed in a direction that faces the battery cells 200.

The fire extinguishing member 700-8 may be exposed toward the battery cell 200, and thus, when a fire occurs in the battery cell 200, the fire extinguishing member 700-8 may be configured to immediately extinguish the battery cell 200, so that heat transfer inside the battery module 100 (see FIG. 1) may be prevented.

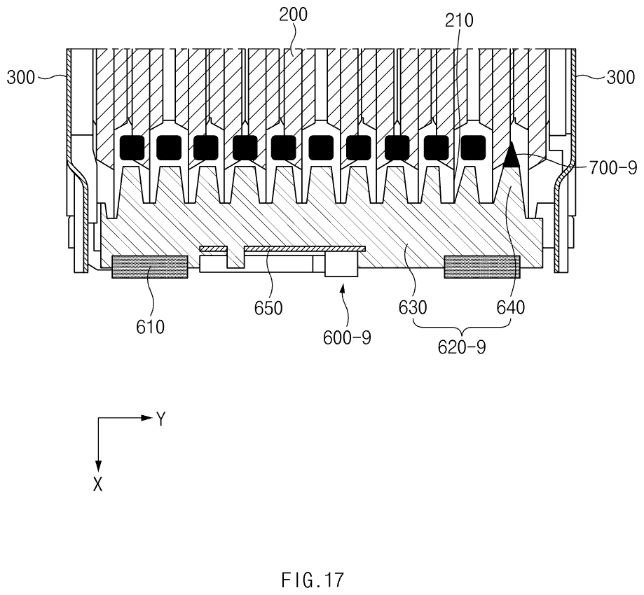

FIG. 17 illustrates a transverse cross-sectional view of a portion of a battery module, according to an exemplary embodiment of the present disclosure.

Referring to FIG. 17, a sensing assembly 600-9 may comprise a busbar 610, a busbar frame 620-9, a sensing board 650, and a fire extinguishing member 700-9.

The busbar 610 may be configured to be electrically connected to the lead part 210 of each of the plurality of battery cells 200.

The busbar frame 620-9 may comprise a frame body area 630 that extends in the second direction (the Y direction or an opposite direction to the Y direction) to support the busbar 610, and a guide body area 640 that protrudes from the frame body area 630 toward spaces between the plurality of battery cells 200.

The guide body area 640 may have a shape, a width of which becomes smaller as it goes toward the battery cells 200 from the frame body area 630 to guide the lead part 210 of each of the plurality of battery cells 200.

The fire extinguishing member 700-9 may be in a form that comprises the fire extinguishing material 710 (see FIG. 4) and a capsule 720 that contains the fire extinguishing material 710, and may be disposed in an area between the guide body area 640 of the busbar frame 620-9 and the battery cell 200.

That is, the fire extinguishing member 700-9 may be configured to be inserted into and fixed in position in an area between the lead part 210 of each of the pair of adjacent battery cells 200 and the guide body area 640.

A plurality of fire extinguishing members 700-9 may be provided. The capsule of each of the plurality of fire extinguishing members 700-9 may be formed in various shapes to include one of circular, rectangular, or triangular cross sections on a cross section that is perpendicular to the third direction (the Z direction or an opposite direction to the Z direction).

The shape of each capsule may be appropriately selected to match the shape of the lead part 210 and the guide body area 640.

Even with this structure, the sensing assembly 600-9 may comprise the fire extinguishing member 700-9 that is provided in an area between the busbar frame 620-9 and the battery cell 200 and may be formed to be exposed in a direction that faces the battery cells 200.

When a fire occurs in the battery cell 200, the fire extinguishing agent of the fire extinguishing member 700-7 may be configured to immediately extinguish the battery cell 200, so that heat transfer in the interior of the battery module 100 (see FIG. 1) may be prevented.

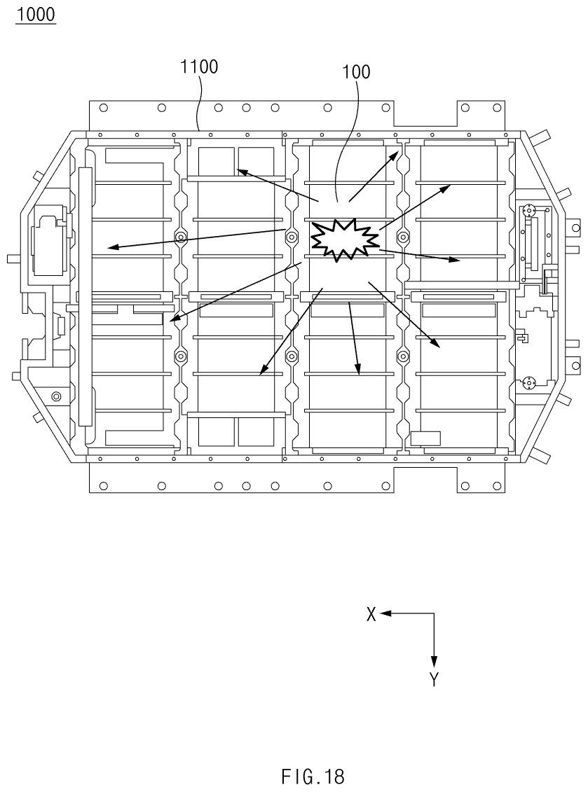

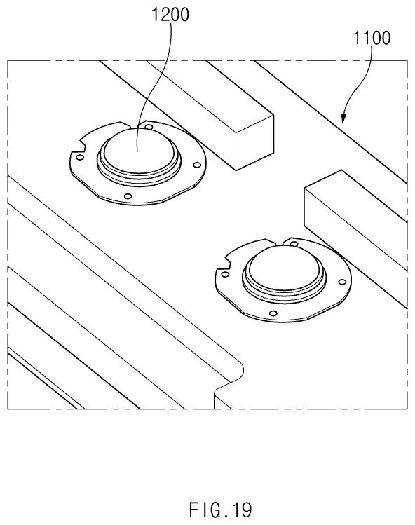

FIG. 18 illustrates a plan view of a battery pack, to which a battery module is applied, according to an exemplary embodiment of the present disclosure. FIG. 19 illustrates a view of a venting device of the battery pack illustrated in FIG. 18, according to an exemplary embodiment of the present disclosure.

Referring to FIGS. 18 and 19, a battery pack 1000 may comprise a pack housing 1100 and a plurality of battery modules 100 that are accommodated in an interior of the pack housing 1100.

The battery module 100 may comprise any one of the sensing assemblies 600, 600-4, 600-5, 600-6, 600-7, 600-8, and 600-9 illustrated in FIGS. 1 to 17.

With this structure, heat transfer between adjacent battery cells 200 in the interior of the battery module 100 may be prevented. Accordingly, flames generated from the battery cell 200, in which a fire has occurred, may be prevented from spreading to adjacent battery modules 100.

Accordingly, only the fluid, such as gas or smoke, which is caused by the fire in the battery cell 200 may be discharged from the battery module 100, and for this purpose, a venting device 1200 for discharging the fluid, such as gas or smoke, may be provided in the pack housing 1100 of the battery pack 1000. The venting device 1200 may be formed to break at a specific pressure or higher.

According to the above principle, when a fire occurs in the battery cell 200 (see FIG. 3), the fire extinguishing member 700, 700-1, 700-2, 700-3, 700-4, 700-5, 700-6, 700-7, 700-8, or 700-9 may be configured to extinguish the fire, so that heat transfer between the battery cells 200 may be prevented, and a thermal runaway in the interior of the battery pack 1000 may be prevented, whereby the safety of the battery pack 1000 may be enhanced.

According to the present technology, because the fire extinguishing member may be disposed between the busbar frame and the battery cell to immediately extinguish the battery cell, in which a fire has occurred, a heat transfer to the adjacent battery cells in the interior of the battery module may be prevented.

In addition, according to the present technology, because the fire extinguishing member guides the lead part of the battery cell between the busbar frame and the battery cell, electrical connection between the battery cell and the busbar may be stabilized without any additional structure.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A battery module comprising:
a plurality of battery cells; and
a sensing assembly disposed on surfaces of the plurality of battery cells to face the plurality of battery cells,
wherein the sensing assembly comprises:
an electrical conductor unit electrically connected to the plurality of battery cells; and
a fire extinguishing member configured to be exposed in a direction facing the battery cells.

2. The battery module of claim 1, wherein:
the electrical conductor unit comprises a busbar,
the sensing assembly comprises a busbar frame configured to support the busbar,
the busbar frame comprises an inner surface facing the battery cells,
the fire extinguishing member is configured to be exposed in a direction facing the battery cells, and
the fire extinguishing member is fixed to the inner surface.

3. The battery module of claim 2, wherein:
the busbar frame comprises a fixing groove formed on the inner surface to be concave, and
the fire extinguishing member comprises:
a fire extinguishing material; and
a capsule configured to:
accommodate the fire extinguishing material; and
be inserted into the fixing groove.

4. The battery module of claim 3, wherein the capsule comprises:
a capsule body configured to accommodate the fire extinguishing material; and
a protruding rib configured to:
protrude from the capsule body; and
be inserted into the fixing groove.

5. The battery module of claim 4, wherein:
the plurality of battery cells are arranged in a first direction,
the fixing groove extends in a second direction crossing the first direction, and
the protruding rib is inserted into the fixing groove in the second direction crossing the first direction.

6. The battery module of claim 4, wherein the protruding rib comprises:
an insertion area inserted into the fixing groove configured to be stopped by the busbar frame; and
a connection area connecting the insertion area and the capsule body, and having a smaller width than a width of the insertion area.

7. The battery module of claim 4, further comprising:
a pair of fixing grooves configured to be spaced apart from each other in a first direction, wherein the plurality of battery cells are arranged in the first direction; and
a pair of protruding ribs configured to be inserted into the pair of fixing grooves, respectively,
wherein each of the pair of protruding ribs comprises:
a connection area extending from an end of the capsule body in a direction toward the fixing groove; and
an insertion area extending from the connection area in a direction crossing the direction in which the connection area extends, and stopped by the busbar frame.

8. The battery module of claim 4, wherein the capsule body has a shape, a width of which decreases as it goes from the inner surface toward the battery cells such that the capsule body guides lead parts of the battery cells.

9. The battery module of claim 3, further comprising:
an adhesive member configured to attach the fire extinguishing member to the inner surface to fix the fire extinguishing member,
wherein the fire extinguishing member comprises:
a fire extinguishing material; and
a capsule configured to:
accommodate the fire extinguishing material; and
be attached to the inner surface by the adhesive member.

10. The battery module of claim 1, wherein:
the plurality of battery cells are arranged in a first direction,
the electrical conductor unit comprises a busbar,
the sensing assembly comprises a busbar frame configured to support the busbar,
the busbar frame comprises:
a frame body area extending in the first direction while supporting the busbar; and
a guide body area protruding from the frame body area toward a space between the plurality of battery cells,
the guide body area is configured to guide lead parts of the battery cells, and
the fire extinguishing member is attached onto a guide body surface of the guide body area, which faces the battery cells.

11. The battery module of claim 1, wherein:
the electrical conductor unit may comprise a busbar,
the sensing assembly comprises a busbar frame configured to support the busbar, and
the fire extinguishing member is filled in areas between the busbar frame and the battery cells.

12. The battery module of claim 1, wherein:
the plurality of battery cells are arranged in a first direction,
the electrical conductor unit comprises a busbar,
the sensing assembly comprises a busbar frame configured to support the busbar,
the busbar frame comprises:
a frame body area extending in the first direction and supporting the busbar; and
a guide body area protruding from the frame body area toward spaces between the plurality of battery cells,
the guide body area is configured to guide lead parts of the battery cells, and
the fire extinguishing member is inserted into an area between a lead part of each of the pair of adjacent battery cells, among the plurality of battery cells, and the guide body area.

13. The battery module of claim 1, wherein:
the plurality of battery cells are arranged in a first direction,
the fire extinguishing member comprises:
a fire extinguishing material; and
a capsule configured to accommodate the fire extinguishing material, and
the capsule comprises a circular, rectangular, or triangular cross section on a cross section being perpendicular to a second direction crossing the first direction.

14. The battery module of claim 1, wherein:
the electrical conductor unit comprises a busbar,
the sensing assembly comprises a busbar frame configured to support the busbar, and
the fire extinguishing member is provided in an area between the busbar frame and the battery cells.

15. A battery module comprising:
a plurality of battery cells; and
a sensing assembly disposed on surfaces of the plurality of battery cells to face the plurality of battery cells,
wherein the sensing assembly comprises:
an electrical conductor unit electrically connected to the plurality of battery cells; and
a fire extinguishing material.

16. The battery module of claim 15, wherein:
the plurality of battery cells are arranged in a first direction,
the electrical conductor unit comprises a busbar,
the sensing assembly comprises a busbar frame extending in the first direction and configured to support the busbar, and
the busbar frame comprises:
a frame body area extending in the first direction and supporting the busbar;
a guide body area protruding from the frame body area toward a space between the plurality of battery cells and defining an accommodation space accommodating the fire extinguishing material in an interior thereof; and
a cover area seated on the guide body area configured to close the accommodation space.

17. The battery module of claim 15, wherein the accommodation space extends in a second direction crossing the first direction.

18. A battery module comprising:
a sensing assembly disposed on surfaces of a plurality of battery cells to face the plurality of battery cells,
wherein the sensing assembly comprises:
an electrical conductor unit electrically connected to the plurality of battery cells; and
a fire extinguishing member.

19. The battery module of claim 18, wherein:
the electrical conductor unit comprises a busbar,
the sensing assembly comprises a busbar frame configured to support the busbar,
the busbar frame comprises an inner surface facing the battery cells, and
the fire extinguishing member is fixed to the inner surface.

20. The battery module of claim 19, wherein:
the busbar frame comprises a fixing groove formed on the inner surface to be concave, and
the fire extinguishing member comprises:
a fire extinguishing material; and
a capsule configured to:
accommodate the fire extinguishing material; and
be inserted into the fixing groove.
